(19) United States
(12) Patent Application Publication
(10) Pub. No.: US 2021/0009132 A1
(43) Pub. Date: Jan. 14, 2021

(54) TRAVEL CONTROL DEVICE AND TRAVEL CONTROL METHOD

(71) Applicant: ISUZU MOTORS LIMITED, Tokyo (JP)

(72) Inventor: Naoki TAKAHASHI, Yokohama-shi, Kanagawa (JP)

(21) Appl. No.: 16/482,810

(22) PCT Filed: Feb. 1, 2018
(86) PCT No.: PCT/JP2018/003429

§ 371 Date: Aug. 1, 2019

(30) Foreign Application Priority Data
Feb. 3, 2017 (JP) 2017-018717

(51) Int. Cl. B60W 30/18

(52) U.S. Cl. CPC B60W 30/18072; B60W 2540/10; B60W 2540/20; B60W 2540/16; B60W 2520/10; B60W 2540/12

(57) ABSTRACT

An automatic travel control unit (120) of this travel control device (100) makes a vehicle travel according to a travel schedule including driven travel and inertial travel. When an accelerator opening degree output from an accelerator sensor (31) exceeds a first threshold value, an inertial travel control unit (110) prohibits inertial travel, and when the accelerator opening degree is smaller than a second threshold value that is less than the first threshold value, the automatic travel control unit (120) performs a control operation so as to cancel the prohibition of inertial travel.

### TECHNICAL FIELD

The present disclosure relates to a travel control device and a travel control method for controlling travel of a vehicle.

### BACKGROUND ART

Patent Literature (hereinafter, referred to as “PTL”) 1 discloses ending coasting travel during the coasting travel and then prohibiting the coasting travel when a coasting travel prohibition condition that the rate of change in accelerator opening degree is equal to or less than a predetermined negative first threshold is satisfied.

### CITATION LIST

### Patent Literature

PTL 1

Japanese Patent Application Laid-Open No. 2016-118240

### SUMMARY OF INVENTION

### Technical Problem

However, in a coasting travel control based on the accelerator opening degree such as that in PTL 1, there is a possibility that a travel state may be switched frequently. For example, there is a possibility that the travel state is switched frequently into or from the coasting travel by accelerator operation unintentionally performed by a driver whose foot is merely placed on the accelerator.

An object of the present disclosure is therefore to provide a technique which makes it possible to switch the travel state of the vehicle appropriately.

### Solution to Problem

A travel control device according to the present disclosure includes: an automatic travel control section that causes a vehicle to travel in accordance with a travel schedule including driven travel and coasting travel; and a coasting travel control section that controls the automatic travel control section such that the coasting travel is prohibited when an accelerator opening degree exceeds a first threshold, or such that the prohibition of the coasting travel is prohibited when the accelerator opening degree falls below a second threshold that is smaller than the first threshold.

### Advantageous Effects of Invention

According to the present disclosure, the travel state of a vehicle can be switched appropriately.

### BRIEF DESCRIPTION OF DRAWINGS

FIG. 1 illustrates an exemplary configuration of a vehicle including a travel control device according to one embodiment of the present disclosure;

FIG. 2 illustrates an example of functional blocks of the travel control device;

FIG. 3 illustrates an example of road grade information and a travel schedule;

FIG. 4 is an explanatory view for explaining an example of a control of coasting travel; and

FIG. 5 is a flowchart illustrating an example of operation by the travel control device.

### DESCRIPTION OF EMBODIMENTS

Hereinafter, an embodiment of the present disclosure will be described with reference to the accompanying drawings.

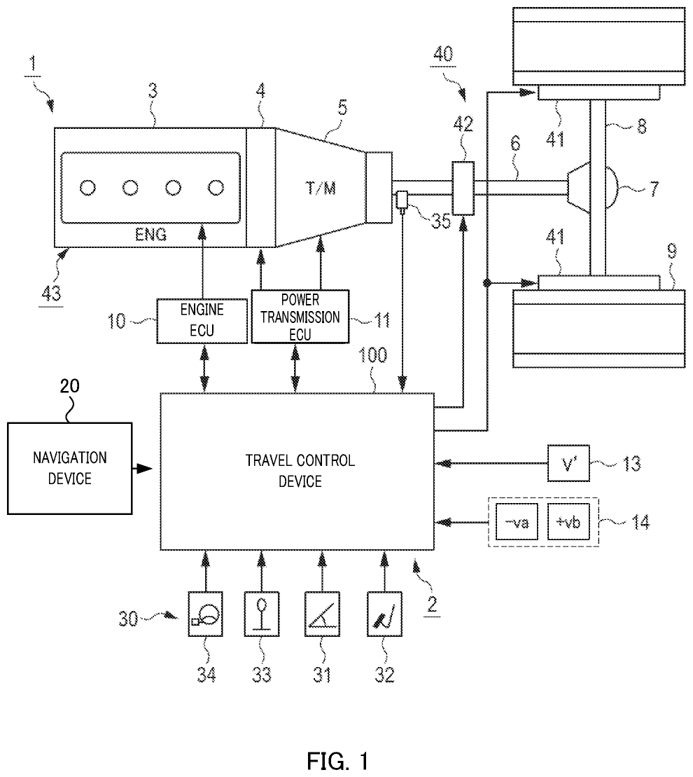

FIG. 1 illustrates an exemplary configuration of a vehicle including a travel control device according to one embodiment of the present disclosure. Vehicle 1 illustrated in FIG. 1 is, for example, a large vehicle such as a truck in which a straight-six diesel engine is mounted. Note that, the coasting travel refers to coasting travel in the case where a gear position of a gearbox is in neutral position in the following descriptions.

As illustrated in FIG. 1, vehicle 1 includes engine 3, clutch 4, gearbox (transmission) 5, thrust shaft (propeller shaft) 6, differential device (differential gear) 7, driving shaft (drive shaft) 8, and wheels 9 as components of a driving system for traveling.

The power of engine 3 is transmitted to gearbox 5 via clutch 4. The power transmitted to gearbox 5 is further transmitted to wheels 9 via thrust shaft 6, differential device 7, and driving shaft 8. Accordingly, the power of engine 3 is transmitted to wheels 9, so that vehicle 1 travels.

Vehicle 1 also includes braking device 40 as a component of a braking system for stopping the vehicle. Braking device 40 includes footbrakes 41 for applying the resistance to wheels 9, retarder 42 for applying the resistance to thrust shaft 6, and auxiliary brake 43, such as an exhaust brake for applying a load to the engine.

Vehicle 1 further includes automatic travel device 2 as a component of a control system for controlling the automatic travel of vehicle 1. Automatic travel device 2 is a device allowing vehicle 1 to automatically travel by controlling the output of engine 3, connection or disconnection of clutch 4, and gear shift of gearbox 5, and automatic travel device 2 includes a plurality of control devices.

Specifically, automatic travel device 2 includes engine Electronic Control Unit (ECU) (engine control device) 10, power transmission ECU (power transmission control device) 11, target-vehicle-speed setting device 13, increase-value/decrease-value setting device 14, navigation device 20, vehicle information obtaining device 30, and travel control device 100. Note that, engine ECU 10, power transmission ECU 11, and travel control device 100 are connected to one another by an in-vehicle network, so that they can transmit and receive required data and control signals to and from one another.

Engine ECU 10 controls the output of engine 3. Power transmission ECU 11 controls the connection or disconnection of clutch 4 and the gear shift of gearbox 5.

Target-vehicle-speed setting device 13 sets, for travel control device 100, target vehicle speed V′ of vehicle 1 during automatic travel. Increase-value/decrease-value setting device 14 sets, for travel control device 100, speed decrease value −va and speed increase value +vb of vehicle 1 during automatic travel. These values, “V′,” “−va,” and “+vb” are parameters used for the automatic travel of vehicle 1.

Target-vehicle-speed setting device 13 and increase-value/decrease-value setting device 14 include an information input interface, such as a display having a touch panel and being disposed, for example, on a dashboard (not illustrated) of a driver's seat, and target-vehicle-speed setting device 13 and increase-value/decrease-value setting device 14 receive setting of the aforementioned parameters input by a driver. Target vehicle speed V′, speed decrease value −va, and speed increase value +vb may appropriately be referred to as “setting information.”

Navigation device 20 receives a global positioning system (GPS) signal, obtains road information indicating the current position of vehicle 1 and road conditions, and outputs them to travel control device 100.

The road information includes the road grade information indicating the road grades at places of a road for generation of the below-mentioned travel schedule. The road grade information is data in which horizontal positions (latitude and longitude information or the like) of the places of the road are associated with altitudes (road altitudes) at the corresponding positions, for example.

Vehicle-information obtaining device 30 obtains vehicle information indicating driver operation information and/or the state of vehicle 1, and outputs the vehicle information to travel control device 100. For example, vehicle-information obtaining device 30 includes accelerator sensor 31 that detects an opening degree (depressed amount) of an accelerator pedal, brake switch 32 that detects whether or not a brake pedal is stepped on, shift lever 33, turn signal switch 34, and vehicle-speed sensor 35 that detects vehicle speed V of vehicle 1.

Travel control device 100 generates a travel schedule including the driven travel and coasting travel based on the aforementioned setting information, road information, and vehicle information. Then, travel control device 100 controls each part of vehicle 1 so that vehicle 1 travels in accordance with the generated travel schedule. However, travel control device 100 prohibits the coasting travel or cancels the prohibition of the coasting travel based on the accelerator opening degree output from accelerator sensor 31 as describe below.

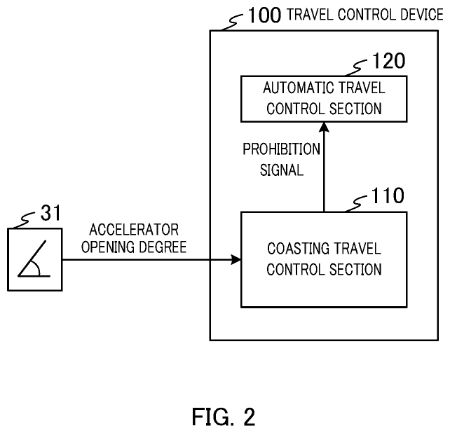

FIG. 2 illustrates an example of functional blocks of travel control device 100. FIG. 2 also illustrates accelerator sensor 31 illustrated in FIG. 1 in addition to travel control device 100. As illustrated in FIG. 2, travel control device 100 includes coasting travel control section 110 and automatic travel control section 120.

Accelerator sensor 31 outputs the accelerator opening degree as described above.

The accelerator opening degree output from accelerator sensor 31 is received by coasting travel control section 110 of travel control device 100.

Based on the accelerator opening degree output from accelerator sensor 31, coasting travel control section 110 controls automatic travel control section 120 such that the coasting travel is prohibited or such that the prohibition of the coasting travel is canceled.

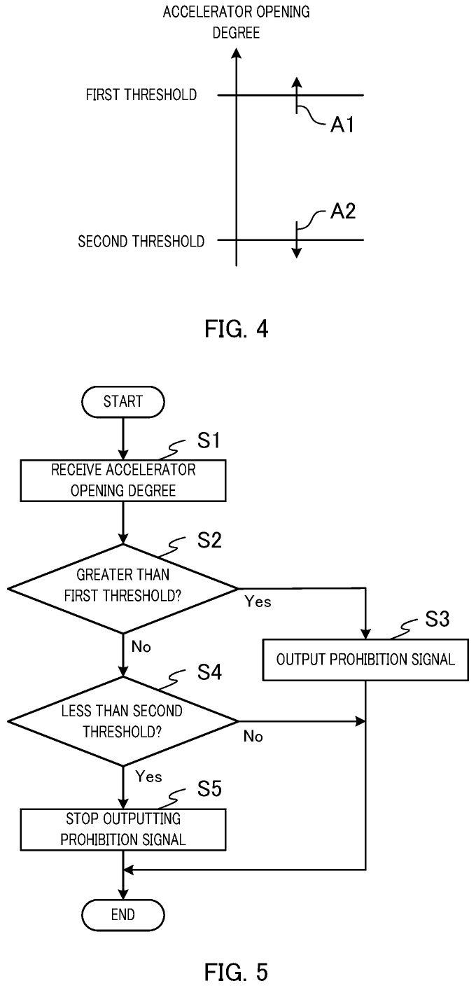

For example, when the accelerator opening degree exceeds a first threshold (see, e.g., arrow A1 in FIG. 4), coasting travel control section 110 outputs a prohibition signal to automatic travel control section 120 in order that the coasting travel is prohibited. In addition, when the accelerator opening degree falls below a second threshold that is less than the first threshold (see, e.g., arrow A2 in FIG. 4), coasting travel control section 110 stops outputting the prohibition signal to automatic travel control section 120 in order that the prohibition of the coasting travel is canceled.

Automatic travel control section 120 generates the travel schedule including the driven travel and coasting travel, and causes vehicle 1 to travel in accordance with the generated travel schedule based on the current position of vehicle 1.

For example, automatic travel control section 120 achieves travel at a speed in accordance with the travel schedule by controlling the fuel injection quantity of engine 3 and/or the like via power transmission ECU 11 during the driven travel. In addition, automatic travel control section 120 disconnects clutch 4 via power transmission ECU 11 during the coasting travel. Moreover, automatic travel control section 120 controls each part of braking device 40 appropriately to stop vehicle 1.

Here, a description will be given of an example of the travel schedule. Automatic travel control section 120 generates, sequentially at a constant interval, a travel schedule for a predetermined travel distance from the current position of vehicle 1 or a travel schedule for a predetermined time period from the current time. These travel schedules are generated to satisfy travel conditions that an average moving vehicle speed is target vehicle speed V′, the maximum vehicle speed during the coasting travel is equal to or less than “Vₘₐₓ′=V′+vb,” and the minimum vehicle speed during the coasting travel is equal to or greater than “Vₘᵢₙ′=V′−va,” for example

For example, automatic travel control section 120 generates the travel schedule for preferentially performing the coasting travel on a downhill road based on the road information. Further, automatic travel control section 120 generates the travel schedule including switching from the driven travel to the coasting travel in front of a crest on condition that the vehicle speed will be equal to or greater than acceptable minimum vehicle speed Vₘᵢₙ′ at the crest where the road changes from an upslope to a downslope.

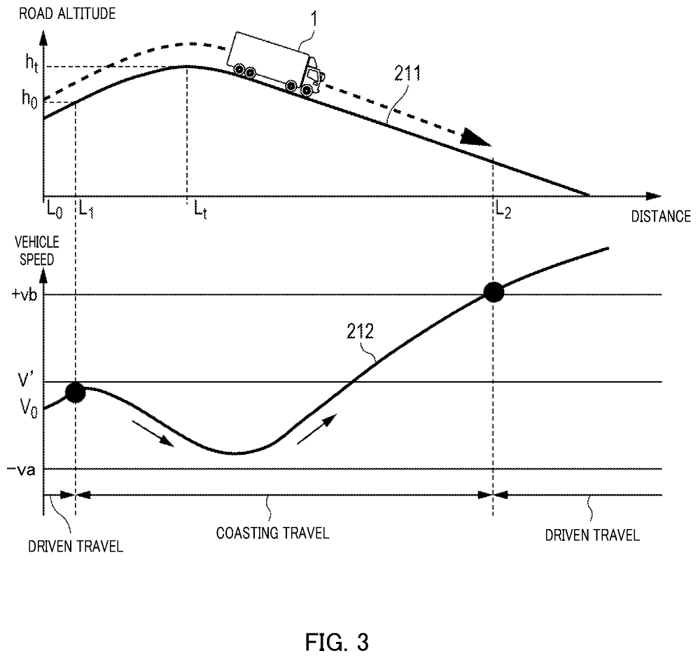

FIG. 3 illustrates an example of road grade information and a travel schedule. For example, the road grade information includes information indicating a road altitude per horizontal distance (road distance) from current position L₀ of vehicle 1 as illustrated by upper solid line 211 in FIG. 3. Note that the horizontal distance from current position L₀ of vehicle 1 may be replaced by the elapsed time from the current time. In addition, the road altitude may be replaced by the road grade based on the relationship with road altitudes in the front and in the rear. The road grade information of solid line 211 indicates that current position L₀ of vehicle 1 is in the middle of an upslope and that there is a downslope immediately after the upslope.

For example, automatic travel control section 120 successively determines whether or not a part (hill crest) where the road changes from an upslope to a downslope is present within a predetermined distance range of the road ahead on the basis of the road grade information.

Then, when there is a hill crest, automatic travel control section 120 determines whether the vehicle can travel through the hill crest by the coasting travel in the case where switching to the coasting travel is performed at position L₁ immediately after current position L₀. That is, automatic travel control section 120 calculates whether or not the vehicle speed at the hill crest will be equal to or greater than acceptable minimum vehicle speed Vₘᵢₙ′. Automatic travel control section 120 performs the above-mentioned calculation based on current vehicle speed v₀, the travel resistance coefficient of vehicle 1 determined in advance by experiments and the like, and the road grade information.

When switching to the coasting travel is performed at the upslope, the vehicle speed is gradually reduced. However, in the case where the speed is high or the distance to the crest is short enough to maintain the vehicle speed at acceptable minimum vehicle speed Vₘᵢₙ′ (V′−va) or greater at a position near the downslope, the above-mentioned travel condition that the minimum vehicle speed of the coasting travel is equal to or greater than acceptable minimum vehicle speed Vₘᵢₙ′ can be satisfied even when switching to the coasting travel is performed at the upslope.

When automatic travel control section 120 determines that the vehicle can pass through the hill crest by the coasting travel, automatic travel control section 120 determines that switching to the coasting travel is performed at position L₁ immediately after position L₀, and that the coasting travel is maintained until the vehicle reaches position L₂ where the vehicle speed falls outside the range of Vₘᵢₙ′ to Vₘₐₓ′ (V′−va to V′+vb), for example. Then, automatic travel control section 120 generates the travel schedule in which switching to the coasting travel is performed at point L₁ and the coasting travel is maintained until the vehicle reaches point L₂ as indicated by lower solid line 212 in FIG. 3.

Specifically, automatic travel control section 120 calculates estimation value vₜ of the vehicle speed at crest position Lₜ in the case where vehicle 1 performs the coasting travel to crest position Lₜ (such an estimation value is hereinafter referred to as “estimation crest vehicle speed”), for example, using following Equation (1).

$${v}_{t} = \sqrt{\begin{matrix}\frac{2}{M} \{ \frac{1}{2} {Mv}_{0}^{2} + {Mgh}_{0} - ( {Mgh}_{t} + λ \cdot {v}_{0}^{2} \cdot g \cdot \\ \frac{Δ x}{cos {θ}_{0}} + μ \cdot Mg \cdot Δ x ) \}\end{matrix}} \qquad ( Equation 1 )$$

Here, M represents the current vehicle weight of vehicle 1, g the gravitational acceleration, ho the altitude at current position L₀ of vehicle 1, hₜ the altitude at crest position Lₜ, μ the roll resistance coefficient of vehicle 1, and Δx the distance (road distance) in the horizontal direction from current position L₀ to crest position Lₜ.

Then, when the calculated estimation crest vehicle speed vₜ is equal to or greater than the set acceptable minimum vehicle speed Vₘᵢₙ′, automatic travel control section 120 determines that, when the coasting travel is being performed, the coasting travel is maintained, whereas, when the driven travel is being performed, the driven travel is switched to the coasting travel. That is, automatic travel control section 120 generates the travel schedule indicated by solid line 212 in FIG. 3, for example, and controls vehicle 1 in accordance with the schedule.

Such a travel schedule including a coasting travel section determined based on the road grade information effectively improves the fuel economy of vehicle 1. In addition, with the control of vehicle 1 to travel in accordance with the travel schedule, driver's successive accelerator operation is unnecessary. In the following description, the automatic travel in accordance with the travel schedule including the driven travel and the coasting travel which is generated based on the road grade information is referred to as “eco-map cruise travel.”

A description will be given with reference to FIG. 2 again. In a case where coasting travel control section 110 outputs the prohibition signal, automatic travel control section 120 does not perform the coasting travel even when the travel schedule indicates the coasting travel. Automatic travel control section 120 performs the coasting travel when no prohibition signal is output from coasting travel control section 110 and the travel schedule indicates the coasting travel.

FIG. 4 is an explanatory view for explaining an example of a control of the coasting travel. The first threshold illustrated in FIG. 4 is greater than the second threshold. The first threshold is a value at which the accelerator opening degree is 5% (100% represents the full opening), for example, and the second threshold is a value at which the accelerator opening degree is 2%, for example.

It is supposed that the accelerator is stepped on when vehicle 1 is in the coasting travel. Coasting travel control section 110 does not output the prohibition signal to automatic travel control section 120 when the accelerator opening degree output from accelerator sensor 31 is less than the first threshold. That is, stepping on the accelerator only slightly does not cause the coasting travel to be canceled (the coasting travel is not canceled when the accelerator opening degree is less than the first threshold), and vehicle 1 continues the coasting travel.

On the other hand, automatic travel control section 120 outputs the prohibition signal to coasting travel control section 110 when the accelerator opening degree output from accelerator sensor 31 exceeds the first threshold as indicated by arrow A1. Accordingly, automatic travel control section 120 cancels (ends) the coasting travel of vehicle 1, and controls such that vehicle 1 performs travel according to the accelerator opening degree, for example. That is, when the driver steps on the accelerator hard (when the accelerator is stepped on such that the accelerator opening degree exceeds the first threshold), the coasting travel is canceled in vehicle 1 and vehicle 1 is accelerated in accordance with the driver's accelerator operation. That is, the driver can cancel the coasting travel and accelerate vehicle 1 by stepping on the accelerator hard.

Once the accelerator opening degree has exceeded the first threshold and coasting travel control section 110 has output the prohibition signal, coasting travel control section 110 continues outputting the prohibition signal until the accelerator opening degree falls below the second threshold. That is, once the coasting travel has been canceled, the coasting travel is prohibited in vehicle 1 and vehicle 1 is accelerated in accordance with the driver's accelerator operation until the driver releases the accelerator to some extent (until the driver releases the accelerator such that the accelerator opening degree falls below the second threshold).

When the accelerator opening degree falls below the second threshold as indicated by arrow A2, coasting travel control section 110 stops to output the prohibition signal, so that automatic travel control section 120 controls such that vehicle 1 performs the coasting travel.

Once the accelerator opening degree has fallen below the second threshold and coasting travel control section 110 has stopped outputting the prohibition signal, coasting travel control section 110 stops outputting the prohibition signal until the accelerator opening degree exceeds the first threshold. That is, stepping on the accelerator only slightly does not cause the coasting travel to be canceled (the coasting travel is not canceled when the accelerator opening degree is less than the first threshold), and vehicle 1 continues the coasting travel.

As understood, the prohibition signal output from coasting travel control section 110 has a hysteresis. Travel control device 100 can thus prevent the travel state from being switched by the accelerator operation being unintentionally and frequently performed by the driver, for example. Travel control device 100 can also accelerate vehicle 1 from the coasting travel in accordance with the driver's intentional accelerator operation.

Note that, while the above descriptions have been given in relation to vehicle 1 in the coasting travel, the same descriptions apply to vehicle 1 in the driven travel. For example, during the driven travel, the prohibition signal is not output from coasting travel control section 110 unless the accelerator opening degree exceeds the first threshold. Accordingly, vehicle 1 can proceed from the driven travel to the coasting travel (the coasting travel is not prohibited) in accordance with the travel schedule unless the accelerator opening degree exceeds the first threshold.

A description will be given of an example of operation of travel control device 100.

FIG. 5 is a flowchart illustrating an example of operation of travel control device 100. Travel control device 100 carries out processing in the flowchart illustrated in FIG. 5 on a predetermined cycle, for example, when travel control device 100 receives the operation of the eco-map cruise travel from the driver. Note that, it is supposed that automatic travel control section 120 are causing vehicle 1 to perform the coasting travel according to the eco-map cruise travel.

To begin with, coasting travel control section 110 receives the accelerator opening degree from accelerator sensor 31 (step S1).

Next, coasting travel control section 110 determines whether or not the accelerator opening degree received at step S1 exceeds the first threshold (step S2). Coasting travel control section 110 outputs the prohibition signal to automatic travel control section 120 when it is determined that the accelerator opening degree received at step S1 exceeds the first threshold (“Yes” at S2) (step S3). Then, coasting travel control section 110 ends the processing of the flowchart. Automatic travel control section 120 thus prohibits the coasting travel of vehicle 1.

On the other hand, when coasting travel control section 110 determines that the accelerator opening degree received at step S1 is not greater than the first threshold (“No” at S2), coasting travel control section 110 determines whether or not the accelerator opening degree received at step S1 is less than the second threshold (step S4). Coasting travel control section 110 stops outputting the prohibition signal to automatic travel control section 120 when it is determined that the accelerator opening degree received at step Si is less than the second threshold (“Yes” at S4) (step S5). Automatic travel control section 120 thus cancels the prohibition of the coasting travel of vehicle 1.

Meanwhile, coasting travel control section 110 ends the processing of the flowchart when it is determined that the accelerator opening degree received at step S1 is not less than the second threshold (“No” at S4).

As described above, travel control device 100 includes automatic travel control section 120 that causes vehicle 1 to travel in accordance with the travel schedule including the driven travel and the coasting travel. In addition, travel control device 100 includes coasting travel control section 110 that controls automatic travel control section 120 such that the coasting travel is prohibited when the accelerator opening degree output from accelerator sensor 31 exceeds the first threshold, or such that the prohibition of the coasting travel is canceled when the accelerator opening degree falls below the second threshold that is less than the first threshold. Travel control device 100 can thus switch the travel state of the vehicle appropriately.

This application is based on Japanese Patent Application No. 2017-018717 filed on Feb. 3, 2017, the disclosure of which is incorporated herein by reference in its entirety.

### INDUSTRIAL APPLICABILITY

The travel control device according to the present disclosure is suitable for use in a vehicle that travels in accordance with a travel schedule including driven travel and coasting travel.

### REFERENCE SIGNS LIST

31 Accelerator sensor

100 Travel control device

110 Coasting travel control section

120 Automatic travel control section

What is claimed is:

1. A travel control device, comprising:
an automatic travel control section that causes a vehicle to travel in accordance with a travel schedule including driven travel and coasting travel; and
a coasting travel control section that controls the automatic travel control section such that the coasting travel is prohibited when an accelerator opening degree exceeds a first threshold, or such that the prohibition of the coasting travel is canceled when the accelerator opening degree falls below a second threshold that is smaller than the first threshold.

2. The travel control device according to claim 1, wherein,
after the accelerator opening degree has exceeded the first threshold, the coasting travel control section prohibits the coasting travel with respect to the automatic travel control section until the accelerator opening degree falls below the second threshold.

3. The travel control device according to claim 1, wherein,
after the accelerator opening degree has fallen below the second threshold, the coasting travel control section cancels the prohibition of the coasting travel with respect to the automatic travel control section until the accelerator opening degree exceeds the first threshold.

4. A travel control method, comprising:
causing a vehicle to travel in accordance with a travel schedule including driven travel and coasting travel; and
prohibiting the coasting travel when an accelerator opening degree exceeds a first threshold, or canceling the prohibition of the coasting travel when the accelerator opening degree falls below a second threshold that is smaller than the first threshold.
